(19) United States
(12) Patent Application Publication
(10) Pub. No.: US 2013/0163805 A1
(43) Pub. Date: Jun. 27, 2013

(54) SECURING APPARATUS FOR A VIBRATION SPEAKER

(71) Applicants: Wen Chung Wang, New Taipei City (TW); Tsi-Yu Chuang, Changhua County (TW); Chien-Hsuan Yen, New Taipei City (TW); Chien-Chang Chen, Taoyuan County (TW)

(72) Inventors: Wen Chung Wang, New Taipei City (TW); Tsi-Yu Chuang, Changhua County (TW); Chien-Hsuan Yen, New Taipei City (TW); Chien-Chang Chen, Taoyuan County (TW)

(73) Assignee: CHIEF LAND ELECTRONIC CO., LTD., NEW TAIPEI CITY (TW)

(21) Appl. No.: 13/366,301

(22) Filed: Feb. 4, 2012

(30) Foreign Application Priority Data
Dec. 27, 2011 (TW) 100148802

(51) Int. Cl. H04R 1/02

(52) U.S. Cl. 381/387

(57) ABSTRACT

The invention is directed to a securing apparatus for a vibration speaker, the securing apparatus including at least one fastening plate fixed to or pressed on the vibration speaker; and at least one suction cup correspondingly attached to the fastening plate. When the at least one suction cup is adhered to a vibration plate, the suction cup draws the fastening plate, which then presses on the vibration speaker, such that the bottom of the vibration speaker bonds with the vibration plate.

### CROSS-REFERENCE TO RELATED APPLICATIONS

The entire contents of Taiwan Patent Application No. 100148802, filed on Dec. 27, 2011, from which this application claims priority, are incorporated herein by reference.

### BACKGROUND OF THE INVENTION

1. Field of the Invention

The present invention generally relates to a securing apparatus, and more particularly to an adhering apparatus of suction cup.

2. Description of Related Art

A speaker (or “loudspeaker”) is a transducer that transforms an electrical signal to an acoustic wave. A conventional moving-coil speaker occupies large volume, consumes great power and is liable to magnetic field. Therefore, the conventional moving-coil speaker is not adaptable to miniaturization or portability for electronic devices. In order to overcome the disadvantages mentioned above, a vibration speaker is thus proposed.

The vibration speaker produces sound. by propagating generated vibration energy to a vibration plate that is in contact with the vibration speaker. The conventional vibration speaker makes contact with the vibration plate via a magnet, clay, a polyurethane (IPU) adhesive or a suction cup that is fixed to the bottom of the vibration speaker. These securing devices, however, absorb the vibration energy, therefore reducing effectiveness in producing the sound. Further, the conventional securing device generally cannot be firmly secured to the vibration speaker, resulting in the vibration speaker falling off.

Therefore, a need has arisen to propose a novel securing apparatus for a vibration speaker to enhance effectiveness in producing sound, and increase secureness between the vibration speaker and the vibration plate.

### SUMMARY OF THE INVENTION

In view of the foregoing, the embodiment of the present invention provides a securing apparatus for a vibration speaker to increase boundness between the vibration speaker and a vibration plate, therefore enhancing vibration propagation and sound producing.

According to one embodiment, a securing apparatus for a vibration speaker includes at least one fastening plate and at least one suction cup. The fastening plate fixes to or presses on the vibration, speaker, and the suction cup correspondingly attaches to the corresponding fastening plate. When the at least one suction cup is adhered to a vibration plate, the suction cup draws the fastening plate, which then presses on the vibration speaker, such that a bottom of the vibration speaker bonds with the vibration plate.

### BRIEF DESCRIPTION OF THE DRAWINGS

FIG. 1A shows a disassembled perspective view of a securing apparatus for a vibration speaker according to a first embodiment of the present invention;

FIG. 1B shows an assembled perspective view of FIG. 1A;

FIG. 1C shows a perspective view of a detachable suction cup;

FIG. 1D shows a perspective view of another detachable suction cup;

FIG. 2A shows an assembled perspective view of a modified first embodiment;

FIG. 2B shows an assembled perspective view of another modified first embodiment;

FIG. 3A shows a cross-sectional view of the suction cup according to the embodiment of the present invention;

FIG. 3B shows a cross-sectional view of the suction cup of FIG. 3A when the pressing element is pressed;

FIG. 4A shows a disassembled perspective view of a securing apparatus for a vibration speaker according to a second embodiment of the present invention;

FIG. 4B shows an assembled perspective view of FIG. 4A;

FIG. 5 shows an assembled. perspective view of a securing apparatus for a vibration speaker according to a third embodiment of the present invention;

FIG. 6A shows an assembled perspective view of a modified third embodiment;

FIG. 6B shows an assembled perspective view of another modified third embodiment;

FIG. 7A shows an assembled perspective view of a securing apparatus for a vibration speaker according to a fourth embodiment of the present invention; and

FIG. 7B shows an assembled perspective view of a modified fourth embodiment.

### DETAILED DESCRIPTION OF THE INVENTION

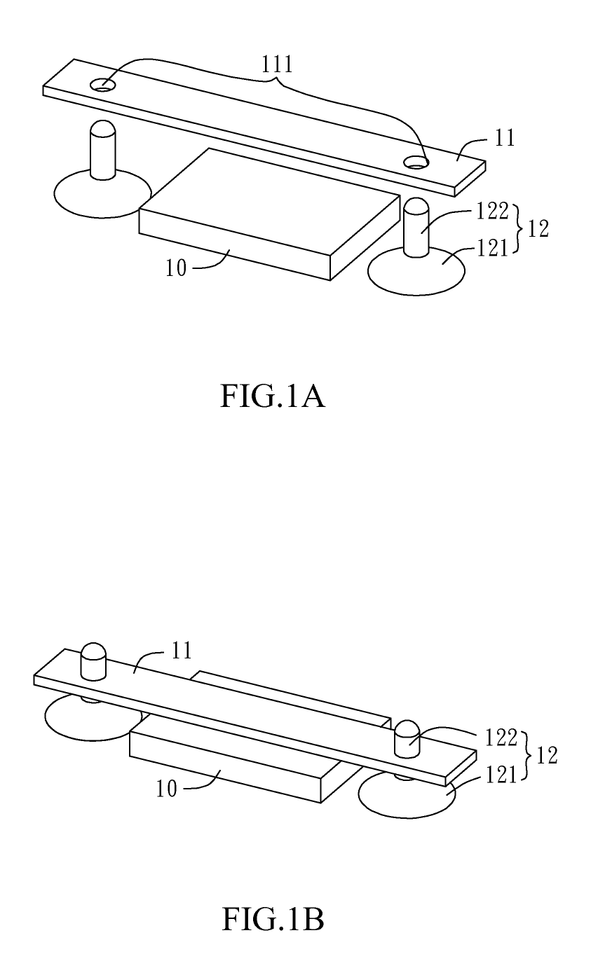

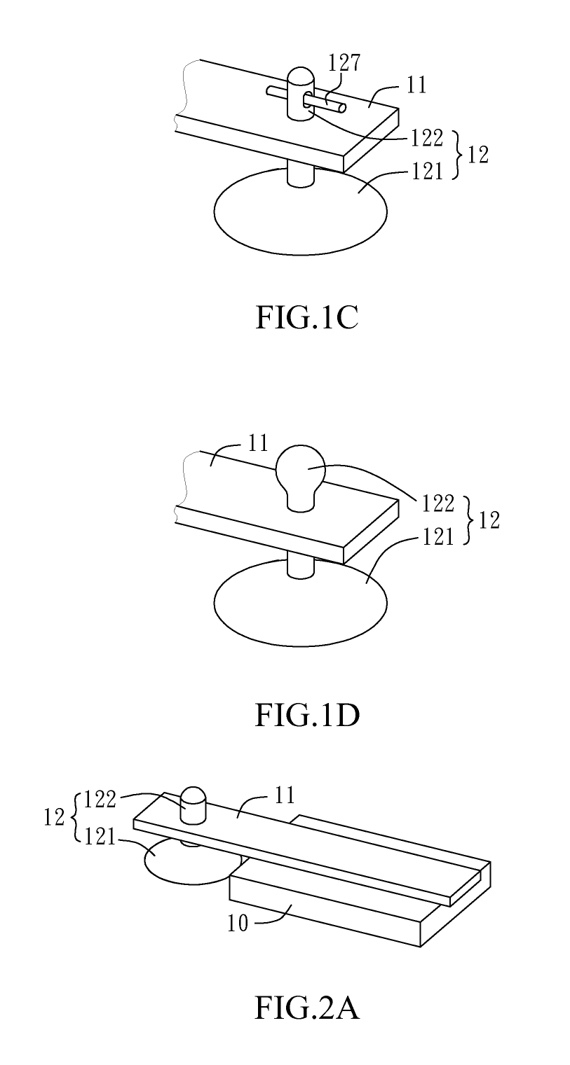

FIG. 1A shows a disassembled perspective view of a securing apparatus for a vibration speaker 10 according to a first embodiment of the present invention. FIG. 1B shows an assembled. perspective view of FIG. 1A. The vibration speaker 10 mentioned in this specification includes a transducer, which generates mechanical vibration that is then propagated to a vibration plate (not shown) to produce sound. The transducer includes a smart material that may be a piezoelectricc material, an electro-active polymer (EAP), a shape memory alloy (SMA), a magnetostrictive material or an electrostrictive material.

The securing apparatus of the embodiment includes a fastening plate 11. and a suction cup 12. The fastening plate 11 may, but not necessarily, have a plate shape. The fastening plate 11 may be made up of a rigid material or a flexible material. The suction cup 12 includes an elastic cup 121 and a rod 122. The fastening plate 11 has a fastening portion 111, corresponding to the rod 122, for attaching the suction cup 12.

In the embodiment, the fastening portion 111 is a hole, passing through the fastening plate 11, for allowing the rod 122 of the suction cup 12 to pass through, thereby attaching the suction cup 12 to the fastening plate 11. As shown in FIG. 1B, two ends of the fastening plate 11 have their respective fastening portions 111, and the rods 122 of two suction cups 12 respectively pass through the fastening portions 111. When the suction cups 12 adhere to a vibration plate (not shown), the suction cups 12 draw the fastening plate 11, which then presses on the top of the vibration speaker 10, such that the bottom of the vibration speaker 10 bonds with the vibration plate.

The combination of the suction cup 12 and the fastening plate 11 of the embodiment may be detachable. FIG. 1C shows a perspective view of a detachable suction cup 12, which is attached to the fastening plate 11 by using a pin 127 that passes through a hole of the rod 122. FIG. 1D shows a perspective view of another detachable suction cup 12, which has a bump at its top that facilitates attaching the suction cup 12 to the fastening plate 11. In addition to the attachable suction cups 12 illustrated in FIG. 1C and FIG. 1D, other detachable schemes may be adopted. For example, corresponding surfaces of the rod. 122 and the fastening portion 111 may have screw threads (not shown), such that the suction cup 12 can be screwed into the fastening plate 11.

The combination of the suction cup 12 and the fastening plate 11 may be non-detachable, wherein the rod 122 and the fastening portion 111 are integrally formed.

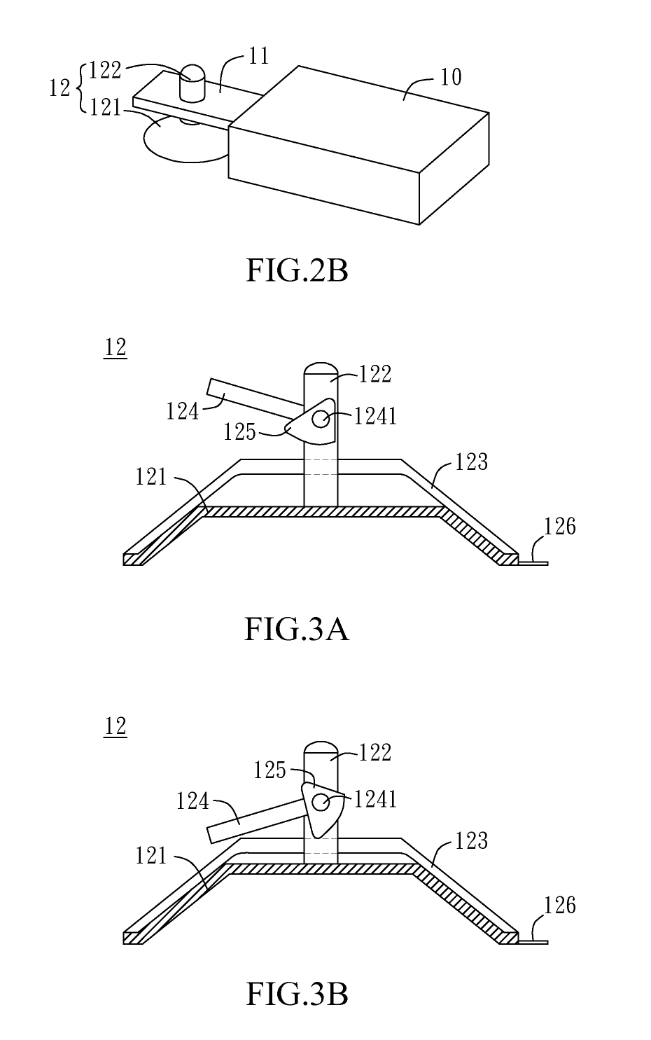

FIG. 2A shows an assembled perspective view of a modified first embodiment. In the embodiment, a single suction cup 12 is used. When the suction cup 12 is adhered to the vibration plate (not shown), the suction cup 12 draws the fastening plate 11, a bottom surface of which then presses on a top surface of the vibration speaker 10, such that the bottom of the vibration speaker 10 bonds with the vibration plate.

FIG. 2B shows an assembled perspective view of another modified first embodiment. In the embodiment, a single suction cup 12 is used. Nevertheless, one end of the fastening plate 11 opposite to the fastening portion 111 is fixed to a side surface of the vibration speaker 10. When the suction cup 12 is adhered to the vibration plate (not shown), the suction cup 12 draws the fastening plate 11, one end of which then exerts force on a side surface of the vibration speaker 10, such that the bottom of the vibration speaker 10 bonds with the vibration plate. According to this embodiment, an overall height may be substantially reduced compared to that of FIG. 2A or FIG. 1B.

FIG. 3A shows a cross-sectional view of the suction cup 12 according to the embodiment of the present invention. In addition to the elastic cup 121 and the rod 122, the suction cup 12 of the embodiment further includes a suction cap 123, a pressing element 124, and a cam (or a bulge) 125, wherein the suction cap 123 covers the elastic cup 121. The suction cap 123 has an opening at its center that allows the rod 122 to pass through and connect to a top of the elastic cup 121. A rotation axis 1241 passes through the rod 122 and one end of the pressing element 124; and the cam 125 is fixed to the rotation axis 1241. As shown in FIG. 3B, when the pressing element 124 is pressed to draw the earn 125, which then resists the suction cap 123, the rod 122 and the elastic cup 121 are therefore pulled up. Accordingly, the space between the suction cup 12 and the vibration plate becomes larger, and the inner pressure becomes lower, thereby enhancing adhesion of the suction cup 12. Further, a strip 126 is disposed on a bottom edge of the elastic cup 121. When the strip 126 is pulled, air enters the suction cup 12 to increase its inner pressure and thus reduce the adhesion of the suction cup 12, therefore facilitating the removal of the suction cup 12 from the surface of the vibration plate.

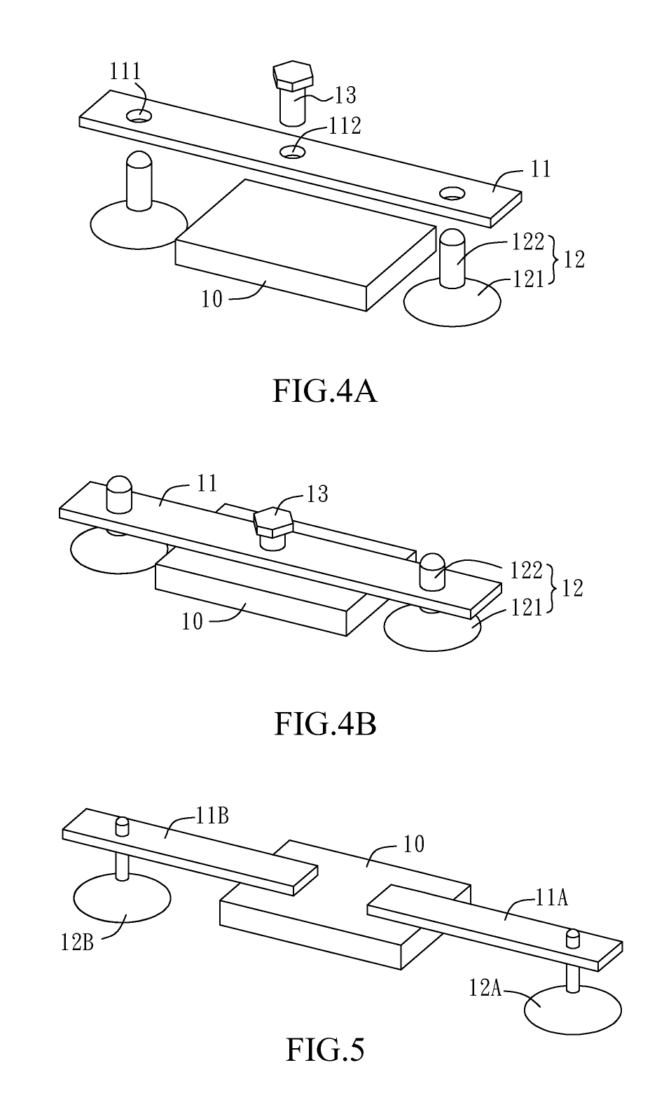

FIG. 4A shows a disassembled perspective view of a securing apparatus for a vibration speaker 10 according to a second embodiment of the present invention. FIG. 4B shows an assembled perspective view of FIG. 4A. The present embodiment is similar to the first embodiment, with the exception that the present embodiment further includes an adjustment device for adjusting a distance or contact force between the bottom of the vibration speaker 10 and the vibration plate (not shown). In the embodiment, the adjustment device includes an adjusting screw 13 and a screw hole 112 correspondingly disposed in the fastening plate 11. As shown in FIG. 4B, the screw hole 112 may, but not necessarily, be disposed at a center of the vibration speaker 10. When the adjusting screw 13 is screwed toward the fastening plate 11, the adjusting screw 13 presses on the top of the vibration speaker 10, therefore decreasing the distance or increasing the contact force between the bottom of the vibration speaker 10 and the vibration plate. Accordingly, the mechanical vibration energy may be effectively propagated to the vibration plate to enhance the sound quality produced by the vibration speaker.

FIG. 5 shows an assembled perspective view of a securing apparatus for a vibration speaker 10 according to a third embodiment of the present invention. The present embodiment is similar to the first embodiment (FIG. 1B), with the exception that the present embodiment uses two fastening plates, that is, a first fastening plate 11A and a second fastening plate 11B, which are similar to the fastening plate 11 of FIG. 2A. The first fastening plate 11A and the second fastening plate 11B are disposed at two opposite ends of the vibration speaker 10. Two suction cups, that is, a first suction cup 12A and a second suction cup 12B, are attached to the first fastening plate 11A and the second fastening plate 11B, respectively. The bottoms of the first/second fastening plates 11A/B press on the top of the vibration speaker 10, such that the bottom of the vibration speaker 10 bonds with the vibration plate.

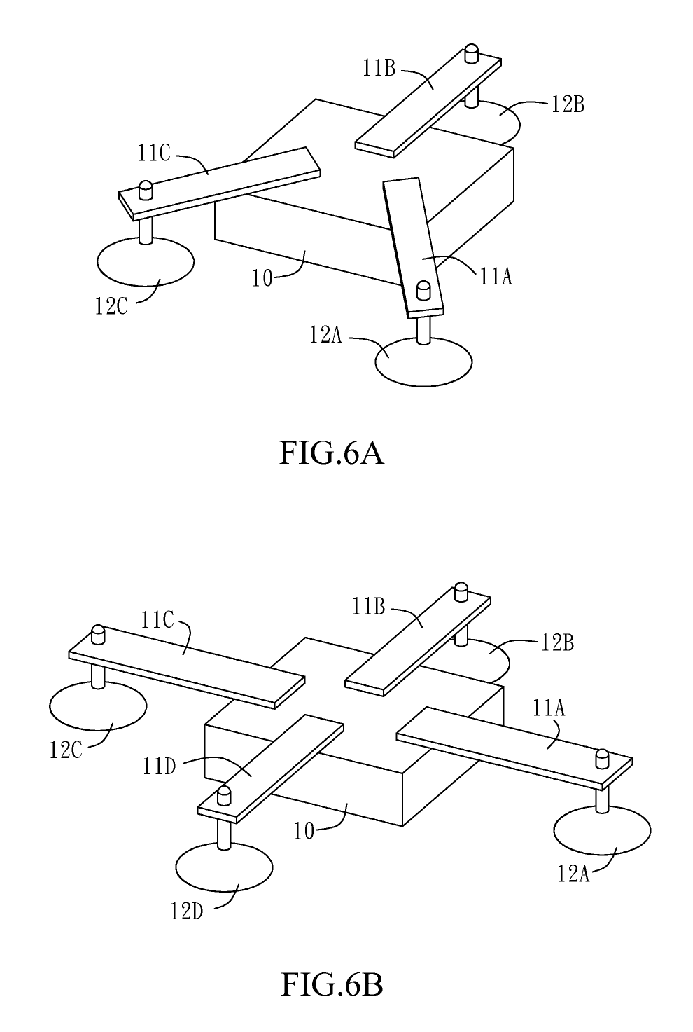

FIG. 6A shows an assembled perspective view of a modified third embodiment. In the embodiment, three fastening plates (i.e., a first fastening plate 11A, a second fastening plate 11B, and a third fastening plate 11C) and three corresponding suction cups (i.e., a first suction cup 12A, a second suction cup 12B, and a third suction cup 12C) are used.

FIG. 6B shows an assembled perspective view of another modified third embodiment. In the embodiment, four fastening plates (i.e., a first fastening plate 11A, a second fastening plate 11B, a third fastening plate 11C, and a fourth fastening plate 11D) and four corresponding suction cups (i.e., a first suction cup 12A, a second suction cup 12B, a third suction cup 12C, and a fourth suction cup 12D) are used. As more fastening plates and suction cups are used in FIG. 6A and FIG. 6B than in FIG. 5, more effective boundness between the vibration speaker 10 and the vibration plate may thus be achieved.

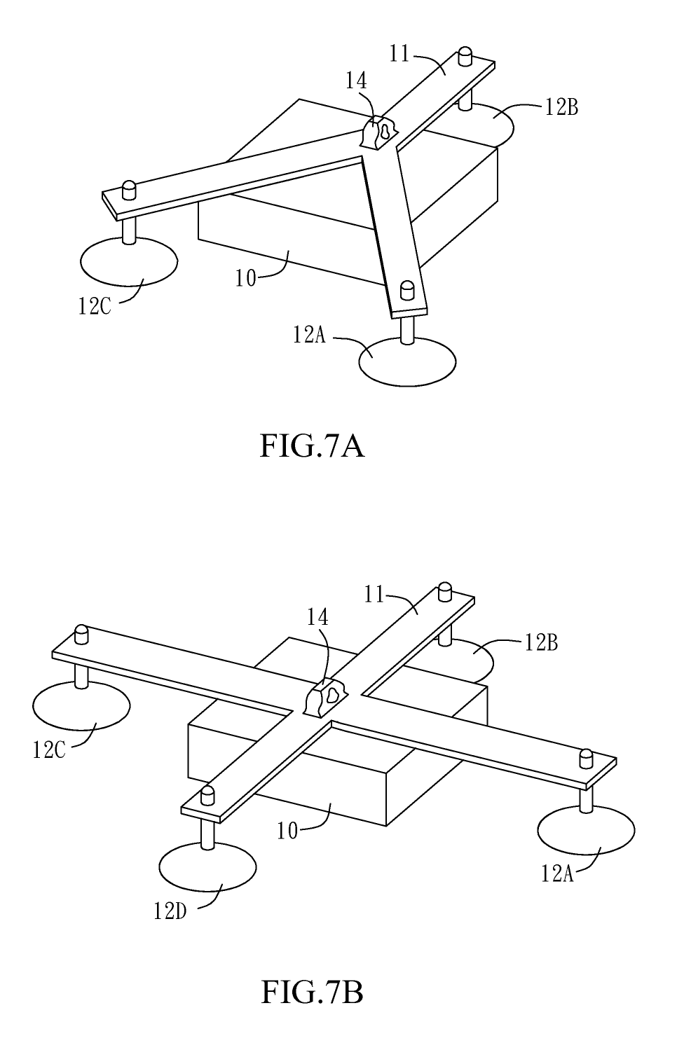

FIG. 7A shows an assembled perspective view of a securing apparatus for a vibration speaker 10 according to a fourth embodiment of the present invention. The present embodiment is similar to the securing apparatus shown in FIG. 6A, with the exception that the three fastening plates are integrally formed. In other words, first ends of the three fastening plates are connected together, and fix to or press on the vibration speaker 10. The second ends of the three fastening plates are attached to the suction cups 12A/B/C, respectively. Further, the embodiment includes a handle 14, which is disposed, for example, at a top center of the fastening plate 11 (i.e., a position where three fastening plates connect to each other). The handle 14 accordingly facilitates the removal of the fastening plate 11.

FIG. 7B shows an assembled perspective view of a modified. fourth embodiment. The present embodiment is similar to the securing apparatus shown in FIG. 6B, with the exception that the four fastening plates are integrally formed. In other words, first ends of the four fastening plates are connected. together, and fix to or press on the vibration speaker 10. The second ends of the four fastening plates are attached to the suction cups 12A/B/C/D, respectively. Further, the embodiment includes a handle 14, which is disposed, for example, at a top center of the fastening plate 11 (i.e., a position at which four fastening plates connect to each other). The handle 14 accordingly facilitates the removal of the fastening plate 11.

Although specific embodiments have been illustrated and described, it will be appreciated by those skilled. in the art that various modifications may be made without departing from the scope of the present invention, which is intended to be limited solely by the appended claims.

What is claimed is:

1. A securing apparatus for a vibration speaker, comprising:
at least one fastening plate, fixed to or pressed on the vibration speaker; and
at least one suction cup correspondingly attached to the at least one fastening plate;
when the at least one suction cup is adhered to a vibration plate, the suction cup draws the fastening plate, which then presses on the vibration speaker, such that a bottom of the vibration speaker bonds with the vibration plate.

2. The securing apparatus of claim 1, wherein the fastening plate comprises a rigid material or a flexible material.

3. The securing apparatus of claim 1, wherein the suction cup comprises an elastic cup and a rod, wherein the fastening plate has a fastening portion, corresponding to the rod, for attaching the suction cup.

4. The securing apparatus of claim 3, wherein the fastening portion is a hole, passing through the fastening plate, for allowing the rod to pass through, and a pin passes through the rod, thereby attaching the suction cup to the fastening plate.

5. The securing apparatus of claim 3, wherein the fastening portion is a hole, passing through the fastening plate, for allowing the rod to pass through, and the rod has a bump at its top that facilitates attaching the suction cup to the fastening plate.

6. The securing apparatus of claim 3, wherein the fastening portion is a hole, passing through the fastening plate, wherein corresponding surfaces of the rod and the fastening portion have screw threads, such that the suction cup can be screwed into the fastening plate.

7. The securing apparatus of claim 3, wherein the rod and the fastening portion are integrally formed.

8. The securing apparatus of claim 3, wherein two ends of the fastening plate have corresponding two fastening portions, respectively, and each of the fastening portions is correspondingly attached to the corresponding suction cup.

9. The securing apparatus of claim 3, wherein one end of the fastening plate opposite to the fastening portion is fixed to a side or a top surface of the vibration speaker.

10. The securing apparatus of claim 3, wherein the suction cup further comprises:
a suction cap, which covers the elastic cup, and the suction. cap has an opening at its center that allows the rod to pass through the elastic cup;
a pressing element with a rotation axis passing through the rod and one end of the pressing element; and
a cam fixed to the rotation axis;
when the pressing element is pressed to draw the cam, which then resists the suction cap, the rod is therefore pulled up.

11. The securing apparatus of claim 10, wherein the suction cup further comprises a strip disposed on a bottom edge of the elastic cup.

12. The securing apparatus of claim 1, further comprising an adjustment device disposed in the fastening plate for adjusting a distance or contact force between the bottom of the vibration speaker and the vibration plate.

13. The securing apparatus of claim 12, wherein the adjustment device comprises an adjusting screw and a screw hole correspondingly disposed in the fastening plate; when the adjusting screw is screwed toward the fastening plate, the adjusting screw presses on a top of the vibration speaker, therefore decreasing the distance or increasing the contact force between the bottom of the vibration speaker and the vibration plate.

14. The securing apparatus of claim 1, wherein the at least one fastening plate comprises two said fastening plates, each of which corresponds to one said suction cup.

15. The securing apparatus of claim 1, wherein the at least one fastening plate comprises three fastening plates, wherein first ends of the three fastening plates are connected together, and fixed to or pressed on the vibration speaker; second ends of the three fastening plates are attached to the suction cups, respectively.

16. The securing apparatus of claim 15, further comprising handle, which is disposed at a position where the three fastening plates connect.
